(19) United States
(12) Patent Application Publication
(10) Pub. No.: US 2025/0186985 A1
(43) Pub. Date: Jun. 12, 2025

(54) Process for Sulphurising Hydrocarbon Treatment Catalysts

(71) Applicant: EURECAT S.A, La Voulte-Sur-Rhône (FR)

(72) Inventors: Giuseppe Italiano, Valence (FR); Pauline Galliou, Saint Laurent du Pape (FR)

(21) Appl. No.: 18/971,283

(22) Filed: Dec. 6, 2024

(30) Foreign Application Priority Data
Dec. 8, 2023 (FR) 2313808

(51) Int. Cl. B01J 37/20; B01J 37/18; B01J 38/02

(52) U.S. Cl. CPC B01J 37/20; B01J 37/18; B01J 38/02

(57) ABSTRACT

The object of the present invention is a process for sulphurising a hydrocarbon treatment catalyst, comprising:
(i) at least one step of placing the catalyst in contact with an emulsion comprising:
(ia) an aqueous phase comprising at least one acid; and
(ib) an organic phase; then
(ii) at least one step of placing the catalyst in contact with a sulphur-containing gaseous mixture containing hydrogen and a sulphur compound.

The present invention also relates to a process for treating a used catalyst, implementing such a sulphurisation treatment after a regeneration step.

The present invention relates to a process for sulphurising catalysts intended for treating hydrocarbons in particular in the field of oil refinery and of petrochemistry, implementing an emulsion comprising an acid aqueous phase and an organic phase.

### PRIOR ART

Processes for treating hydrocarbons performed in refineries and/or petrochemical units include a certain number of treatments carried out possibly in the presence of hydrogen, which are intended to modify the structure of the hydrocarbon molecules and/or to eliminate hydrocarbon fractions of undesirable compounds such as in particular sulphur, nitrogen, oxygen, aromatic, metal compounds. By way of non-limiting example, the hydrocracking or hydroconversion, reforming, isomerisation, alkylkation, hydrogenation, dehydrogenation processes and the so-called hydrotreatment processes such as hydrodesulphurisation, hydrodenitrogen, hydrodearomatisation, hydrodearomatisation, hydrodemetallation, hydrodeoxygenation processes may be cited.

These processes require specific catalysts, which are in the form of small particles (or catalyst grains) and comprise a porous support based on one or more refractory inorganic oxides, whereon one or more catalytically active metals are deposited. These metals more often comprise one or more metals of group VIII of the periodic table of elements, and/or one or more metals of group VIB.

At the end of the manufacturing of the catalyst, or at the end of the regeneration thereof in the case of an already used catalyst, the metals are in the form of metal oxides that, as are, are not active.

To enable catalysts to be active in the various processes for treating hydrocarbons, it is necessary to carry out sulphurisation of the catalyst, namely a treatment thereof by means of sulphur compounds, in the aim of transforming the metal oxides into mixed sulphides, which constitute the active phase of the catalyst.

This sulphurisation step is particularly important, since it conditions the activity of the catalyst in the subsequent use thereof.

Many sulphurisation processes have been described in the prior art, such as in particular gaseous phase sulphurisation processes wherein the catalyst is treated by means of a gaseous mixture containing sulphur (typically in the form of hydrogen sulphide).

Thus, the patent application EP 1 634 939 describes a sulphurisation process performed in a gaseous phase, by means of a gas containing hydrogen sulphide (H₂S) and hydrogen (H₂), with a H₂S/H₂ molar ratio higher than 4 and a H₂S partial pressure at least equal to 1 kPa.

Many methods intended to improve the performances of these sulphurisation processes have been described.

Thus, the patent application EP 0 993 868 describes a process for ex-situ sulphurisation of a catalyst for the hydroconversion of hydrocarbons, in the presence of hydrogen and of at least one sulphur compound. This process is characterised in that the catalyst is placed in contact with at least one preferably liquid hydrocarbon compound, prior to the sulphurisation. The patent application EP 1 077 085 describes a sulphurisation process that is characterised in that the catalyst is precarbonated so as to deposit in the pores thereof a mostly non-leachable carbonated compound.

Moreover, the patent application EP 1 272 272 describes a process for sulphurising a catalyst containing at least one hydrogenating metal of groups VI and/or VIII and an organic additive, wherein the catalyst is, in a first stage, placed in contact with an organic liquid, then, in a second stage, placed in contact with hydrogen and a gaseous compound containing sulphur, provided that at least 40% of the sulphur present in the sulphurised catalyst has been provided by the organic liquid.

Moreover, the use of sulphurisation auxiliaries such as in particular organic acids is known, which are deposited on the surface of the catalyst before the sulphurisation step.

Thus, the application EP 2 295 521 describes a process for sulphurising a hydrocarbon treatment catalyst, comprising a first step of depositing, on the surface of the catalyst, an unsaturated dicarboxylic acid of particular formula, then a second step of gaseous phase sulphurisation. The acid is deposited by impregnating the catalyst by means of an aqueous solution containing it, followed by a drying step in order to eliminate the water.

The application EP 2 295 522 describes a similar process wherein a thiocarboxylic acid is deposited during the first step.

Pursuing their research in terms of sulphurising hydrotreatment catalysts, the Applicant has now discovered that it is possible to improve gaseous phase sulphurisation processes by treating the catalyst by means of a particular emulsion, prior to the sulphurisation step. The present invention is based on this discovery.

### SUMMARY OF THE INVENTION

Thus, the object of the present invention is a process for sulphurising a hydrocarbon treatment catalyst, comprising:
(i) at least one step of placing the catalyst in contact with an emulsion comprising:
(ia) an aqueous phase comprising at least one acid; and
(ib) an organic phase; then
(ii) at least one step of placing the catalyst in contact with a sulphur-containing gaseous mixture containing hydrogen and a sulphur compound.

The process according to the invention makes it possible to obtain an improved degree of sulphurisation of the catalyst, in relation to the processes of the prior art.

It also makes it possible to significantly improve the activity of the catalyst.

In addition, in relation to a fictive process-not described in the prior art-which would comprise a step of depositing an acid sulphurisation auxiliary in aqueous solution then a step of impregnating a liquid hydrocarbon, the process according to the invention has proven to make it possible to significantly reduce the undesirable catalyst attrition phenomena.

In a manner known per se, the attrition of catalyst particles corresponds to a mechanical wear of said particles by friction of the grains with one another or against the walls of the enclosures containing them, by shocks and/or crushing, in particular during the transport, handling and use of the catalyst. This phenomenon results in a breakage of the particles and an undesired reduction of the size thereof, as well as by the formation of “fines”, that is to say undesirable dust.

The process according to the invention is suitable for the sulphurisation of both new hydrotreatment catalysts, and used hydrotreatment catalysts that have been regenerated beforehand. It is particularly suitable for performing the sulphurisation of used hydrotreatment catalysts, which have been regenerated beforehand.

Thus, another object of the present invention is a process for treating a used hydrotreatment catalyst, implementing the particular sulphurisation process described in the present application following a regeneration step. Such a treatment method thus comprises a step of regenerating the catalyst by heat treatment in the presence of oxygen and at a temperature ranging from 350° C. to 550° C., followed by the sulphurisation process according to the invention.

Other objects, features, aspects and advantages of the invention will appear more clearly upon reading the following description.

Next, and unless stated otherwise, the bounds of a range of values are comprised within this range, in particular in the expressions “comprised between” and “ranging from . . . to . . . ”.

Moreover, the expressions “at least one” and “at least” used in the present description are respectively equivalent to the expressions “one or more” and “higher than or equal to”.

Finally, in a manner known per se, C_{N} compound or group designates a compound or a group containing in its chemical structure N carbon atoms.

### DETAILED DESCRIPTION

### The Aqueous Phase (ia) of the Emulsion

The emulsion implemented in step (i) of the process according to the invention comprises an aqueous phase (ia).

This aqueous phase comprises water and one or more acids, which may be selected from mineral acids and organic acids. It is typically in the form of a solution of the acid(s) in water.

The acid(s) may be present in the form of free acids or in the salified form, for example in the form of alkali metal salts such as sodium and potassium, alkaline earth metal salts such as magnesium salts, and ammonium salts.

Any water-soluble acid can be used at the temperature at which step (i) is performed.

From the mineral acids that can be used, phosphoric acid (H₃PO₄), metaphosphoric acid (HPO₃) and pyrophosphoric acid (H₄P₂O₇) can in particular be cited.

According to a preferred embodiment, the aqueous phase comprises one or more organic acids, preferably selected from carboxylic acids.

The carboxylic acid(s) that can be used in the invention typically contain 1 to 10 carbon atoms. They may contain, apart from the carbon, hydrogen and oxygen atoms, heteroatoms such as in particular sulphur and nitrogen.

Such carboxylic acids may advantageously be selected from monocarboxylic acids, dicarboxylic acids, tricarboxylic acids, aminopolycarboxylic acids and mixtures thereof.

From the monocarboxylic acids, in particular those of formula R—COOH can be cited with R designating a hydrocarbon group, saturated or unsaturated, comprising 1 to 9 carbon atoms and optionally one or more heteroatoms such as sulphur, oxygen and nitrogen. By way of example of such acids, in particular methanoic acid (formic acid), ethanoic acid (acetic acid), lactic acid, glycolic acid, crotonic acid, acrylic acid, thioacids such as 2-hydroxy-4-(methylthio)butanoic acid, thioglycolic acid, aminoacids such as 2-aminoethanoic (glycine) can be cited.

From the dicarboxylic acids, in particular malic acid, maleic acid, malonic acid, itaconic acid, oxalic acid, mesoxalic acid, fumaric acid, succinic acid, tartric acid, glutaric acid, ketoglutaric acid, iminodiacetic acid, galactaric acid (mucic acid), adipic acid, diglycolic acid, valeric acid and mixtures thereof can be cited.

From the tricarboxylic acids, in particular citric acid, iso-citric acid, aconitic acid, oxalosuccinic acid can be cited.

From the aminopolycarboxylic acids, in particular ethylenediaminetetraacetic acid (EDTA), nitrilotriacetic acid (NTA), diethylenetriaminepentaacetic acid (DTPA) can be used.

The carboxylic acid(s) is (are) preferably selected from glycolic acid, thioglycolic acid, maleic acid, citric acid, and mixtures thereof.

According to a particularly preferred embodiment, the aqueous phase contains citric acid.

Preferably, the aqueous phase contains the acid(s) in a content of 5 to 50% by weight, more preferably of 15 to 30% by weight, in relation to the weight of the aqueous phase.

This content is expressed based on the non-salified, free acid form.

Moreover, the acid(s) advantageously represent(s) 3 to 30% by weight, preferably 5 to 20% by weight, in relation to the total weight of the emulsion.

This content is expressed based on the non-salified, free acid form.

Advantageously, the aqueous phase has a pH within the range of 1 to 7, preferably of 1.5 to 3.

The aqueous phase preferably represents 40 to 70% by volume, in relation to the total volume of the emulsion, preferably 50 to 60% by volume.

### The Organic Phase (ib) of the Emulsion

The emulsion implemented in step (i) of the process according to the invention comprises an organic phase (ib).

“Organic phase” means any non-aqueous medium having a water solubility at ambient temperature (25° C.) and at atmospheric pressure (760 mm Hg) less than 1% by weight, and preferably less than 0.5% by weight.

Preferably, the organic phase is liquid at ambient temperature and atmospheric pressure.

Advantageously, the organic phase comprises one or more oils, preferably selected from the compounds and compound mixtures comprising at least one chain having at least 8 carbon atoms. The oil(s) may in particular be selected from vegetable oils, animal oils, mineral oils, synthetic oils and mixtures thereof.

As vegetable oil, by way of examples castor oil, sunflower oil, arachid oil, soya oil, rapeseed oil, copra oil, maize oil, palm oil, linseed oil, and safflower oil can be cited.

Used cooking oils can also be cited, which may comprise vegetable oils and/or animal oils.

Suitable mineral oils are in particular selected from liquid hydrocarbons and hydrocarbon mixtures derived from the distillation of oil, such as in particular and in a non-limiting way: fuel and/or combustible fractions such as petrol, jet oil, naphtha, diesel oil, fuel oil fractions; lubricating oil fractions such as for example an oil marketed under the name “150 Neutral”; solvent fractions such as those known under the name “white spirits”.

Preferred mineral oils are selected from diesel oil fractions (in particular including atmospheric distillation diesel oils and vacuum distillation diesel oils) and solvent fractions selected from C₈ to C₁₄ paraffinic hydrocarbons, C₈ to C₁₄ cycloparaffinic hydrocarbons, aromatic hydrocarbons, and mixtures thereof.

These hydrocarbon mixtures may have, if applicable, been subjected to one or more hydrotreatments, for example hydrodesulphurisation, isomerisation, etc.

As synthetic oil, poly(alpha-olefins) can be cited such as for example polydecenes and polyisobutenes; the hydrocarbons and hydrocarbon mixtures obtained by synthesis such as in particular by a Fischer-Tropsch synthesis process or by vegetable oil hydrotreatment; transesterified vegetable oils.

According to a preferred embodiment, the organic phase comprises one or more mineral oils and/or one or more vegetable oils such as described above.

The organic phase may also comprise one or more solid fats at ambient temperature such as for example waxes.

By way of waxes that can be used in the present invention, waxes of animal origin such as bees wax; vegetable waxes such as sunflower wax; mineral waxes, for example, paraffin waxes, vaseline waxes; synthetic waxes such as polyethylene waxes, waxes derived from a Fischer-Tropsch synthesis; and mixtures thereof, can be cited.

The organic phase preferably represents 30 to 60% by volume, in relation to the total volume of the emulsion, preferably 40 to 50% by volume.

### The Sulphur Compounds (Optional)

According to a preferred embodiment, the emulsion also comprises one or more sulphur compounds, which may be selected from organic sulphur compounds and mineral sulphur compounds.

When the emulsion contains one or more mineral sulphur compounds, this or these sulphur compound(s) are advantageously present in the aqueous phase of the emulsion. Thus, according to a preferred embodiment of the invention, the aqueous phase (ia) contains one or more sulphur compounds, preferably selected from mineral sulphur compounds.

The mineral sulphur compounds may in particular be selected from thiosulphates such as sodium thiosulphate, potassium thiosulphate, ammonium thiosulphate; metabisulphite such as for example sodium metabisulphite, potassium metabisulphite, ammonium metabisulphite; and elementary sulphur (the latter was advantageously in suspension in the aqueous phase).

When the emulsion contains one or more organic sulphur compounds, this or these sulphur compound(s) is (are) advantageously present in the organic phase of the emulsion. Thus, according to a preferred embodiment of the invention, the organic phase (ib) contains one or more sulphur compounds, preferably selected from organic sulphur compounds.

Organic sulphur compounds may in particular be selected from polysulphides, mercaptans, thiols, thiophenes, sulphoxides.

Polysulphides are in particular selected from the compounds of formula R—Sn—R′, wherein:
n is a whole number within the range of 3 to 20, preferably of 3 to 8 and more particularly of 3 to 7, and
R and R′, identical or different, represent organic radicals containing 1 to 150 carbon atoms, preferably 10 to 60 carbon atoms and more particularly 15 to 30 carbon atoms, R′ that may also represent hydrogen. These radicals may be saturated or unsaturated, linear or branched, or cyclic, and may be selected from the group consisting of alkyl radicals, alkenyl radicals, aryl radicals, alkylaryl radicals and arylalkyl radicals, these radicals may include at least one heteroatom.

As an example of polysulphide, di-tert-butyl-polysulphide of formula (CH₃)₃C—S₄—C(CH₃)₃ can be cited.

Mercaptans are in particular selected from the compounds of formula R—SH, wherein R represents an organic radical containing 1 to 150 carbon atoms, preferably 10 to 60 carbon atoms and more particularly 8 to 30 carbon atoms. This radical may be saturated or unsaturated, linear or branched, or cyclic, and may be selected from the group consisting of alkyl radicals, alkenyl radicals, aryl radicals, alkylaryl radicals and arylalkyl radicals, these radicals may include at least one heteroatom.

As an example of mercaptan, 1-nonanethiol of formula CH₃(CH₂)₇CH₂—SH can be cited.

Sulphoxides are in particular selected from the compounds of formula R—SO—R′, wherein R and R′, identical or different, represent organic radicals containing 1 to 150 carbon atoms, preferably 10 to 60 carbon atoms and more particularly 15 to 30 carbon atoms, R′ that may also represent hydrogen. These radicals may be saturated or unsaturated, linear or branched, or cyclic, and may be selected from the group consisting of alkyl radicals, alkenyl radicals, aryl radicals, alkylaryl radicals and arylalkyl radicals, these radicals may include at least one heteroatom.

As an example of sulphoxide, dodecyl methyl sulphoxide of formula CH₃(CH₂)₁₀CH₂—SO—CH₃ can be cited.

Of course, it is possible to use mixtures of organic sulphur compounds as described above.

Generally, the sulphur compound(s) when present advantageously represent(s) 4 to 12% by weight, preferably 6 to 10% by weight, in relation to the total weight of the emulsion.

According to a preferred embodiment, the organic phase of the emulsion contains one or more organic sulphur compounds as described above, more preferably selected from polysulphides, mercaptans, sulphoxides, and the mixtures of these compounds, and more preferably also from polysulphides.

In this embodiment, the organic sulphur compound(s) advantageously represent(s) 10 to 40% by weight, preferably 15 to 25% by weight, in relation to the total weight of the organic phase.

### The Emulsion

The emulsion implemented in step (i) of the process according to the invention may be a direct emulsion (that is to say of the oil-in water type, the organic phase being dispersed in the aqueous phase) or an indirect emulsion (that is to say of the water-in oil type, the aqueous phase being dispersed in the organic phase).

Preferably, this is a direct emulsion, that is to say that the organic phase is dispersed in the aqueous phase.

According to a preferred embodiment, the emulsion further comprises one or more surfactant(s).

The surfactant(s) may advantageously be selected from anionic surfactants, non-ionic surfactants, amphoteric surfactants, and mixtures thereof, preferably from non-ionic surfactants.

As examples of suitable non-ionic surfactants, the following can be cited:
oxyalkylated alkyl(C₈-C₂₄)phenols;
saturated or unsaturated, linear or branched, oxyalkylated or glycerolated C₈ to C₄₀ alcohols, and including one or two fatty chains;
saturated or unsaturated, linear or branched C₈ to C₃₀ acid esters, and polyol or polyethylene glycol esters;
esters of saturated or unsaturated, linear or branched C₈ to C₃₀ acids and of sorbitol, preferably oxyethylenated;
fatty acid and saccharose esters,
alkyl(C₈-C₃₀)(poly)glucosides and alkenyl(C₈-C₃₀)(poly)glucosides, possibly oxyalkylated (0 to 10 oxyalkylene units) and comprising 1 to 15 glucose units; alkyl (C₈-C₃₀)(poly)glucoside esters,
saturated or unsaturated, oxyethylated vegetable oils;
ethylene oxide and/or propylene oxide condensates;
and mixtures thereof.

The oxyalkylated units are more particularly oxyethylated, oxypropylenated units, or combinations thereof, preferably oxyethylated.

The number of moles of ethylene oxide and/or of propylene ranges preferably from 1 to 250, more particularly from 2 to 100; better from 2 to 50; the number of moles of glycerol ranges in particular from 1 to 50, better from 1 to 10.

The non-ionic surfactant(s) is(are) more preferably selected from C₈ to C₂₄ oxyethylated alcohols comprising 1 to 40 moles of ethylene oxide, preferably 2 to 20 moles of ethylene oxide.

The surfactant(s) is(are) preferably present in a total content ranging from 0.1 to 5% by weight, better from 0.2 to 2.5% by weight, and even better from 0.5 to 1.5% by weight, in relation to the total weight of the emulsion.

### Step (i)

Step (i) consists in placing the catalyst particles in contact with the emulsion described above.

Preferably, the volume of emulsion used at this step is higher than or equal to at least 80% of the total porous volume of the catalyst. More preferably, the volume of emulsion used is within the range of 100 to 140% of the total porous volume of the catalyst, and even better of 100 to 120% of the total porous volume of the catalyst.

In a manner known per se, the porous volume of a catalyst is determined by nitrogen adsorption. The porous volume measured by nitrogen adsorption was determined by the Barrett-Joyner-Halenda (BJH) model. The nitrogen adsorption-desorption isotherm according to the BJH model is described in the publication “The Journal of American Society”, 73, 373, (1951) by E. P. Barrett, L. G. Joyner and P. P. Halenda.

Generally, step (i) is carried out by impregnating the catalyst by means of the emulsion, such that the emulsion penetrates into the porosity of the catalyst. To this end, any known means can be used for making a liquid penetrate into porous particles.

For example, it is possible to proceed by dipping and stirring the catalyst in the emulsion.

Preferably, this step is carried out by agitating the catalyst particles, and by spraying the emulsion thereon.

This step may be performed continuously or discontinuously, preferably continuously.

Within the scope of a process in continuous mode, step (i) may be for example performed in one of the following ways:
by spraying the emulsion on the catalyst in a mixing enclosure disposed upstream of the sulphurisation unit;
by spraying the emulsion on the catalyst in the feed system of the sulphurisation unit, for example while the catalyst passes into a vibratory feeder or into a helicoidal screw, with the dual action of mixing the emulsions with the catalyst and feeding the sulphurisation unit(s).

Step (i) may have a variable duration, generally ranging from a few minutes to a few hours. Preferably, this placing in contact lasts around 1 hour.

It may be carried out at a pressure ranging from atmospheric pressure to 5 bars, preferably at atmospheric pressure, and at a preferential temperature ranging from ambient temperature to 100° C.

According to a preferred embodiment, step (i) is carried out at a temperature ranging from 25° C. to 100° C., preferably from 40 to 90° C. and even better from 50 to 80° C.

### The Sulphurisation Step (ii)

The process according to the invention also comprises at least one step (ii), during which the catalyst derived from step (i)—therefore whereon the emulsion is deposited—is placed in contact with a sulphur-containing gaseous mixture containing hydrogen and a sulphur compound.

Advantageously, the sulphur compound is hydrogen sulphide (H₂S), or a sulphur compound likely to release hydrogen sulphide by hydrogenolysis in the operating conditions of this step. Such sulphur compounds may be selected for example from elementary sulphur, CS₂, organic sulphur compounds such as mercaptans, sulphides, disulphides, polysulphides, thiols, thiophenes, sulphoxides.

Preferably, the sulphur compound is hydrogen sulphide.

It is possible to proceed, for example, in the manner described in the patent application EP 1 634 939.

Thus, according to a preferred embodiment of step (ii), the catalyst is placed in contact with a sulphur-containing gaseous mixture containing hydrogen and hydrogen sulphide.

Advantageously, hydrogen sulphide represents 5 to 70% by volume of the hydrogen sulphide+hydrogen mixture, preferably 10 to 60% by volume.

The sulphur-containing gaseous mixture, may, in addition to hydrogen and the sulphur compound, also comprise one or more other gases, such as in particular inert dilution gases, for example nitrogen. Such additional gases may for example represent 5 to 80% by volume of said gaseous mixture.

Step (ii) is advantageously performed at a temperature ranging from 150 to 500° C., preferably from 200 to 350° C.

Preferably, the temperature varies throughout the duration of step (ii). Thus, it is possible to proceed in at least two steps, a first step of gradually increasing the temperature, followed by a second step of levelling at a temperature ranging from 200 to 350° C.

Step (ii) is preferably performed in continuous mode, in a sulphurisation unit containing one or more reactors within which the catalyst particles circulate on contact with the sulphur-containing gaseous mixture.

Step (ii) may be performed in a fixed bed or in a mobile bed, for example in a fluidised or ebullating bed, or in a rotary kiln. In the case of a mobile bed, the sulphur-containing gaseous mixture may circulate co-current or counter-current to the catalyst bed, preferably counter-current.

The amount of sulphur incorporated into the catalyst during this step depends on the amount of active metals present on the surface of the latter. Preferably, the amount of incorporated sulphur represents 50 to 200%, preferably 80 to 120%, more preferably 90 to 110% of the stoichiometric amount of sulphur necessary for the active metals to all be in the form of metal sulphides.

For example, in the case of a catalyst of which the active metals are cobalt and molybdenum, the sulphide forms corresponding to a stoichiometry of 100% may be assimilated to respectively CoS and MoS₂.

### The Process

In the process according to the present invention, step (ii) is performed after step (i). It may be performed directly after step (i), or be separated therefrom by one or more intermediate step(s).

Thus, the process according to the invention may also comprise, between steps (i) and (ii), a step of drying the catalyst, which may be performed at a temperature ranging from 80° C. to 350° C., preferably from 100° C. to 200° C., in open air or in the presence of a gaseous stream of air, of an inert gas such as nitrogen, or any other suitable gas.

According to a preferred embodiment, the process does not comprise an intermediate step, in particular no drying step. In other terms, step (i) is directly followed by step (ii) and the catalyst whereon the emulsion is deposited is directly sulphurised.

The sulphurisation process according to the invention may also further comprise one or more additional steps, which may be performed before and/or after said steps (i) and (ii) described above.

Thus, step (ii) may advantageously be followed by a cooling step, during which the catalyst is brought to ambient temperature, or to a temperature close to ambient temperature. This cooling, generally performed progressively, may be carried out in the presence of a sulphur-containing gaseous mixture, or of any other suitable gas, for example hydrogen, an inert gas such as nitrogen, oxygen, or a mixture of such gases, or of various gaseous mixtures used successively.

Thus, it is possible to proceed to a first phase of cooling the catalyst in sulphur-containing gaseous mixture, followed by a second phase of cooling under inert gas, for example nitrogen.

According to a preferred embodiment of the invention, the process further comprises, after step (ii), a step of passivating the catalyst, which is preferably an oxidising passivation.

This oxidising passivation consists in placing the catalyst in contact with oxygen or a gaseous mixture containing oxygen. Preferably, a gaseous mixture containing less than 30% of oxygen is used. This gaseous mixture may in particular be air. The contact of the catalyst with the gas containing oxygen may be carried out in several stages, with a gradual increase of the oxygen content over time.

The passivation step is preferably performed at a temperature less than or equal to 150° C., for a duration generally less than 24 hours. In particular, it may be performed simultaneously with the step of cooling the catalyst performed at the end of step (ii).

In the case of a sulphurisation process performed ex situ, passivation in particular has the advantage of reducing the pyrophoric tendency of the sulphide phases present on the surface of the catalyst, and therefore of making it possible to easily transfer or store the latter, for example in metal drums or other types of containers.

The process according to the present invention may be carried out in situ, that is to say directly within the unit wherein the catalyst is used.

According to a preferred embodiment, it is carried out ex situ, that is to say after unloading the catalyst from the unit.

### The Hydrotreatment Catalysts

The process according to the present invention makes it possible to sulphurise any catalyst intended for treating hydrocarbons, in the fields of refining and of petrochemistry.

These catalysts are in the form of porous solid particles, which comprise at least one active metal such as in particular a hydrogenating metal deposited on a support based on one or more refractory mineral oxides.

Hydrogenating metal designates a metal of groups VIII and VIB of the periodic table of elements.

Preferably, the catalysts treated by means of the process according to the invention are catalysts containing at least one metal of group VIII of the periodic table of elements, such as for example cobalt, nickel, iron, associated with at least one metal of group VIB such as for example molybdenum, tungsten, chromium. The metal content of group VIII is generally comprised between 0.1 and 10% by weight in relation to the total weight of the catalyst, and the metal content of group VIB is generally comprised between 1 and 20% by weight in relation to the total weight of the catalyst.

The hydrogenating metal(s) is (are) deposited on a support based on one or more refractory mineral oxides such as in particular aluminas, silicas, silica-aluminas, zeolites, zircones, titanium and boron oxides, and mixtures of such oxides.

The process according to the invention is more particularly suitable for the sulphurisation of hydrotreatment catalysts comprising active metals deposited on a non-zeolithic support selected from aluminas, silicas, silica-aluminas. More preferably, said non-zeolithic support contains at least 30% by weight of alumina, and preferably at least 50% by weight.

The process according to the invention is particularly suitable for the sulphurisation of catalysts containing the metal associations CoMo, NiMo, NiW, NiCoMo, deposited on alumina-base supports.

The catalysts treated by means of the process according to the invention may, apart from the hydrogenating metal(s), contain all suitable additional ingredients. Thus, they may contain for example, and in a non-limiting manner, one or more halogen, boron, phosphorus compounds, one or more elements selected from those of groups IIIB, IVB, VB of the periodic table of elements.

The process according to the present invention is particularly suitable for the sulphurisation of catalysts that do not contain any organic additive. Thus, it is particularly suitable for the sulphurisation of catalysts for which the difference between the loss on ignition at 500° C. and the loss on ignition at 150° C. is less than or equal to 2% by weight, in relation to the weight of the initial catalyst.

In a manner well known to the person skilled in the art, the expression “loss on ignition” (LOI) designates the loss of mass resulting from heating a material, due to the departure of volatile materials.

A catalyst containing organic materials such as an organic additive has a significant loss on ignition at 500° C., resulting from the decomposition of these organic materials. Furthermore, due to the high specific surface thereof and the hygroscopic character thereof, the catalysts may absorb a non-negligible amount of water coming among other things from the humidity of the air, which is characterised by a loss on ignition at 150° C. that may range from 5 to 10% by weight. Thus, to determine whether or not a catalyst contains an organic additive, the difference between the loss on ignition at 500° C. and the loss on ignition at 150° C. should be considered.

The hydrocarbon treatment catalysts are generally in the form of small solid particles such as beads, more or less cylindrical particles, extruded parts. It has a specific surface, measured by the BET method, generally comprised between 100 and 300 m²/g, a porous volume, determined by nitrogen adsorption, from 0.25 to 1 ml/g, and an average pore diameter, determined by nitrogen adsorption, from 7 to 20 nm.

Once treated by means of the process according to the present invention, the catalyst is ready for use, and may advantageously be used directly in the hydrocarbon treatment process for which it is intended.

It is also possible to carry out a second sulphurisation treatment of the catalyst, in particular performed in situ, immediately before using the catalyst. In particular, it may concern a sulphurisation treatment performed in the presence of hydrogen by passing through the catalyst a liquid phase containing sulphur, typically a sulphur-containing hydrocarbon fraction and/or enriched with sulphur-containing hydrocarbons, such as for example a distillate possibly added with dimethyl disulphide.

Thus, the process according to the invention may be used as a presulphurisation process, in order to precondition the catalyst, reduce the intensity and the duration of the final sulphurisation treatment performed in situ, therefore to save time, and to increase the efficiency of the hydrocarbon treatment process.

The catalysts obtained by means of the process according to the invention may be used in any industrial process implementing a sulphur-containing catalyst. They are more particularly intended for processes for treating hydrocarbons such as oil fractions, hydrocarbons produced from natural gas, coal, and oxygen-containing or non-plant-based hydrocarbons.

Non-limiting examples of the hydrocracking or hydroconversion, reforming, isomerisation, alkylkation, hydrogenation, dehydrogenation processes and the so-called hydrotreatment processes such as the hydrodesulphurisation, hydrodenitrogen, hydrodearomatisation, hydrodearomatisation, hydrodemetallation, hydrodeoxygenation processes may be cited.

The process according to the present invention is particularly suitable for the sulphurisation of catalysts intended for the oil fraction hydrotreatment processes, and in particular for the hydrodesulphurisation process.

The process according to the invention is suitable for the sulphurisation of both new catalysts, and used catalysts that have been regenerated beforehand. According to a preferred embodiment, the catalyst is a used hydrotreatment catalyst that has been regenerated beforehand.

A used catalyst is a catalyst that, following the use thereof in a hydrotreatment reactor, has been deactivated in particular due to the deposition on the surface thereof of coke, that is to say a mixture of heavy hydrocarbons, of carbon residues, of metal impurities.

The regeneration of used catalysts is a well-known process that consists in performing the combustion of coke, by heating the catalyst to a high temperature in the presence of a gas containing oxygen.

### The Process for Treating a Used Catalyst

Thus, another object of the invention is a process for treating a used catalyst, which comprises:
a step of heat treating the catalyst in the presence of oxygen and at a temperature ranging from 350° C. to 550° C., then;
sulphurising the sulphurisation catalyst by means of the process as described above.

The heat treatment step consists in heating the used catalyst to a temperature ranging from 350° C. to 550° C., in the presence of oxygen. Its aim is to eliminate the coke present on the surface of the catalyst, by combustion of the latter.

Controlling the temperature within the catalyst is essential during this step. The temperature must indeed be sufficiently high to make it possible to burn the coke as completely as possible. However, it must not exceed 550° C., and this even locally, because this would have the effect of damaging the catalyst for example by degrading the porosity of the latter.

Preferably, this heat treatment step is performed at a temperature less than or equal to 530° C., and preferably less than or equal to 520° C.

According to a preferred embodiment, the heat treatment step is performed, totally or partially, at a temperature within the range of 450 to 550° C.

The temperature within the catalyst can be controlled, in a manner known per se, for example by means of thermocouples suitably disposed in the mass of the catalyst.

The first step is performed in the presence of oxygen, for example by means of a gas stream containing oxygen. For example, this gas may consist of air, pure or mixed with additional oxygen or with an inert gas, so as to increase or reduce the oxygen content of air. This gas may also consist of a mixture of oxygen and of an inert gas such as nitrogen, or other gaseous mixtures comprising oxygen.

Preferably, the oxygen content of the gas is controlled, so as to better control the combustion temperature. This content may be fixed, or on the contrary vary over time. The gas flow rate is also controlled so as to control the combustion.

This heat treatment step may comprise several phases, performed at different temperatures and/or in the presence of variable amounts of oxygen.

In general, the total duration of this step depends on the amount of catalyst to be treated, the composition of the latter, the amount of coke present on its surface, and the operating conditions (temperature, oxygen content). This duration is even shorter as temperature is high. In general, it is comprised between 0.1 and 20 hours, preferably between 0.2 and 10 hours.

The following examples are given purely by way of illustration of the present invention.

### EXAMPLES

The examples below were carried out from a conventional used hydrotreatment catalyst of the NiMo type on alumina, derived from a hydrodeoxygenation unit. This catalyst was regenerated by heat treatment in the presence of an oxygen-containing gas in a roto-louvre type unit. This regenerated catalyst (named catalyst C) contains 4% by weight of NiO and 18% by weight of MoO₃ supported on gamma alumina. The porous volume thereof is 0.52 ml/g.

### Comparative Example 1

A sample of 100 g of catalyst C was treated in the following way:
a single step (ii) of placing the catalyst in contact with a gaseous mixture consisting of a H₂S/H₂/N₂ mixture with a H₂S partial pressure of 0.3, a H₂ partial pressure of 0.25 and a N₂ partial pressure of 0.45. This step was performed at atmospheric pressure, in a vertical reactor, with the descending gas stream passing through the catalyst bed at a gas hourly space velocity (GHSV) of 300 h⁻¹. The temperature was increased by 5° C./min up to 250° C., then levelling for 2h at this temperature was respected.

A sample of sulphurised catalyst S1 was thus obtained.

### Comparative Example 2

A sample of 100 g of catalyst C was treated in the following way:
a first step (i) of placing the catalyst in contact with an organic solution consisting of 14.3 g of rapeseed oil (corresponding to 30% of the porous volume of the catalyst), by impregnating the catalyst with this organic solution at a temperature of 60° C. for a period of 1 h, then
a second step (ii) identical to that described in Example 1 above.

A sample of sulphurised catalyst S2 was thus obtained.

### Comparative Example 3

A sample of 100 g of catalyst C was treated in the following way:
a first step (i) of placing the catalyst in contact with 30 ml of a citric acid solution in water having a concentration of 27% by weight of acid (corresponding to 60% of the porous volume of the catalyst), by impregnating the catalyst with this solution at a temperature of 60° C. for a period of 1 h, then
a second step (ii) identical to that described in Example 1 above.

A sample of sulphurised catalyst S3 was thus obtained.

### Comparative Example 4

A sample of 100 g of catalyst C was treated in the following way:
a first step (i) of placing the catalyst in contact with 30 ml of a citric acid solution in water having a concentration of 27% by weight of acid (corresponding to 60% of the porous volume of the catalyst), by impregnating the catalyst with this solution at a temperature of 60° C. for a period of 1 h, then
a second step (i) of placing the catalyst in contact with an organic solution consisting of 14.3 g of rapeseed oil, 4.7 g of di-tert-butyl-polysulphide and 0.19 g of a surfactant consisting of a polyethylene glycol trimethylnonyl ether, marketed under the name Tergitol TMX 100X® (corresponding to 40% of the porous volume of the catalyst), by impregnating the catalyst with this organic solution at a temperature of 60° C. for a period of 1 h, then
a third step (ii) identical to that described in Example 1 above.

A sample of sulphurised catalyst S4 was thus obtained.

### Example 5 According to the Invention

A sample of 100 g of catalyst C was treated in the following way:
a first step (i) of placing the catalyst in contact with an emulsion consisting of: an aqueous phase consisting of 30 ml of a citric acid solution in water having a concentration of 27% by weight of acid (corresponding to 60% of the porous volume of the catalyst), and of an organic phase consisting of 19 g of rapeseed oil and 0.19 g of a non-ionic surfactant consisting of a polyethylene glycol trimethylnonyl ether, marketed under the name Tergitol TMX 100X® (corresponding to 40% of the porous volume of the catalyst),
by impregnating the catalyst with this emulsion at a temperature of 60° C. for a period of 1 h then
a second step (ii) identical to that described in Example 1 above.

A sample of sulphurised catalyst S5 was thus obtained.

### Example 6 According to the Invention

A sample of 100 g of catalyst C was treated in the following way:
a first step (i) of placing the catalyst in contact with an emulsion consisting of: an aqueous phase consisting of 30 ml of a citric acid solution in water having a concentration of 27% by weight of acid (corresponding to 60% of the porous volume of the catalyst), and of an organic phase consisting of 14.3 g of rapeseed oil, 4.7 g of di-tert-butyl-polysulphide and 0.19 g of a non-ionic surfactant consisting of a polyethylene glycol trimethylnonyl ether, marketed under the name Tergitol TMX 100X® (corresponding to 40% of the porous volume of the catalyst),
by impregnating the catalyst with this emulsion at a temperature of 60° C. for a period of 1 h then
a second step (ii) identical to that described in Example 1 above.

A sample of sulphurised catalyst S6 was thus obtained.

### Example 7 According to the Invention

A sample of 100 g of catalyst C was treated in the following way:
a first step (i) of placing the catalyst in contact with an emulsion consisting of: an aqueous phase consisting of 30 ml of a maleic acid solution in water having a concentration of 44% by weight of acid (corresponding to 60% of the porous volume of the catalyst), and of an organic phase consisting of 14.3 g of rapeseed oil, 4.7 g of di-tert-butyl-polysulphide and 0.19 g of a non-ionic surfactant consisting of a polyethylene glycol trimethylnonyl ether, marketed under the name Tergitol TMX 100X 100® (corresponding to 40% of the porous volume of the catalyst),
by impregnating the catalyst with this emulsion at a temperature of 60° C. for a period of 1 h then
a second step (ii) identical to that described in Example 1 above.

A sample of sulphurised catalyst S7 was thus obtained.

### Example 8 According to the Invention

A sample of 100 g of catalyst C was treated in the following way:
a first step (i) of placing the catalyst in contact with an emulsion consisting of:
an aqueous phase consisting of 30 ml of a citric acid solution in water having a concentration of 27% by weight of acid (corresponding to 60% of the porous volume of the catalyst), and of an organic phase consisting of 14.6 g of rapeseed oil, 4.7 g de di-tert-butyl-polysulphide (corresponding to 40% of the porous volume of the catalyst),
by rapidly impregnating (placing in contact for a period less than 5 minutes) the catalyst with this emulsion at a temperature of 60° C. then
a second step (ii) identical to that described in Example 1 above.

A sample of sulphurised catalyst S8 was thus obtained.

### Example 9 According to the Invention

A sample of 100 g of catalyst C was treated in the following way:
a first step (i) of placing the catalyst in contact with an emulsion consisting of: an aqueous phase consisting of 30 ml of a phosphoric acid solution in water having a concentration of 15% by weight of acid (corresponding to 60% of the porous volume of the catalyst), and of
an organic phase consisting of 14.3 g of rapeseed oil, 4.7 g of di-tert-butyl-polysulphide and 0.19 g of a non-ionic surfactant consisting of a polyethylene glycol trimethylnonyl ether, marketed under the name Tergitol TMX 100X® (corresponding to 40% of the porous volume of the catalyst),
by impregnating the catalyst with this emulsion at a temperature of 60° C. for a period of 1 h then
a second step (ii) identical to that described in Example 1 above.

A sample of sulphurised catalyst S9 was thus obtained.

### Example 10: Evaluation of the Performances of the Sulphurised Catalysts S1 to S9

For each of the catalysts described S1 to S9, the following properties were evaluated:

### Determination of the Sulphurisation Rate of the Catalyst

The sulphur content was measured by means of an organic elementary analyser, which makes it possible to determine the C, H, N, O, S contents. The sulphurisation rate (ST1) is defined as being the ratio between the sulphur content of the catalyst measured, expressed on a dry base after correcting the loss on ignition at 500° C. (amount of volatile compounds such as water, evaporated at 500° C.), and the theoretical sulphur content (STO) of the catalyst, corresponding to the sulphurised metals in stoichiometric amount that is to say in the form of sulphides MoS2 and NiS.

The sulphurisation rate is defined by the following formula:

$$ST 1 ( \% ) = 100 * [ S / ( 1 - \frac{LOI}{100} ) ] / ST 0$$

### Determination of the Attrition of the Catalyst

This parameter was determined on samples of 50 g of catalyst, according to the principle disclosed in the standard ASTM D-4058, and that consists in placing a catalyst sample in a cylindrical drum provided on the generatrix thereof with a raiser (sheet metal plate welded on the internal wall of the drum), then after closing the drum using a lid, rotating the assembly for a duration of 30 minutes, then measuring the loss of weight undergone by the catalyst sample, by sieving on a sieve no. 20 (0.85 mm) in order to eliminate the fines produced. The percentage by weight of fines produced is then calculated.

This test makes it possible to simulate successive drops of catalyst particles, which generate the breakage and fines.

### Determination of the Hydrodesulphurisation (HDS) Activity

The test is performed in a pilot unit, by hydrodesulphurising a feed consisting of a diesel oil derived from the direct distillation of crude oil, known as “straight run”, having a sulphur content of 1.514% by weight. The operating conditions were the following: pressure of 5 MPa (50 bars), H₂/feed ratio of 300, gas hourly space velocity GHSV=1.5 h⁻¹, temperature of 360° C. The sulphur content of the feed was measured upon exiting the unit by means of a UV fluorescence analyser.

The apparent constants of the desulphurisation reaction were calculated according to the formula E1 below:

$${K}_{v} = ( \frac{1}{α - 1} ) ( \frac{1}{{S}^{α - 1}} - \frac{1}{{S}_{0}^{α - 1}} ) * VVH \qquad ( E1 )$$

where
Kᵥ=apparent reaction constant
α=reaction order (considered equal to 1.2)
S=sulphur content of the effluents
S₀=sulphur content of the feed
HSV=hourly space velocity of the liquid feed.

The performances of each sample were evaluated in relation to that of a reference catalyst. For this, the Relative Volume Activity (RVA) was calculated according to the following formula E2:

$$RVA = \frac{Kv ( {e}^{′} chantillon )}{Kv ( r {e}^{′} f {e}^{′} rence )} \times 100 \qquad ( E2 )$$

As a reference, the value Kᵥ of 100 was attributed to the corresponding new catalyst, activated in situ (in the unit) by means of a mixture of diesel oil and of dimethyl disulphide.

### Determination of the Hydrodeoxygenation (HDO) Activity

The test is performed in a pilot unit, by hydrodeoxygenating a feed consisting of rapeseed oil. The operating conditions were the following: pressure of 2 MPa (20 bars), H₂/feed ratio of 1,600, gas hourly space velocity GHSV=0.5 h⁻¹, temperature of 295° C.

The oxygen content of the feed was measured entering and exiting the unit.

The apparent constants of the deoxygenation reaction were calculated according to the formula E1 below:

$${K}_{v} = ( \frac{1}{α - 1} ) ( \frac{1}{{0}^{α - 1}} - \frac{1}{{0}_{0}^{α - 1}} ) * VVH \qquad ( {E1}^{′} )$$

where
Kᵥ=apparent reaction constant
α=reaction order (considered equal to 1.4)
O=oxygen content of the effluents
O₀=oxygen content of the feed
HSV=hourly space velocity of the liquid feed.

The performances of each sample were evaluated in relation to that of a reference catalyst. For this, the Relative Volume Activity (RVA) was calculated according to the following formula E2′:

$$RVA = \frac{Kv ( {e}^{′} chantillon )}{Kv ( r {e}^{′} f {e}^{′} rence )} \times 100 \qquad ( {E2}^{′} )$$

As a reference, the value Kᵥ of 100 was attributed to the corresponding new catalyst, activated in situ (in the unit) by means of a mixture of hydrotreated vegetable oil and of dimethyl disulphide.

The results obtained are detailed in Table 1 below.

TABLE 1

| | Sulphurisation ST1 | Attrition | HDS | HDO |
|---|---|---|---|---|
| Catalyst | (rate in %) | (%) | activity (%) | activity (%) |
| S1 | 95 | 0.5 | 92 | 93 |
| S2 | 92 | 0.3 | 98 | 99 |
| S3 | 99 | 3.5 | 96 | 102 |
| S4 | 98 | 4.0 | 103 | 110 |
| S5 | 100 | 0.3 | 110 | 116 |
| S6 | 100 | 0.3 | 117 | 126 |
| S7 | 100 | 0.5 | 115 | 123 |
| S8 | 100 | 1.1 | 108 | 112 |
| S9 | 100 | 0.2 | 107 | 110 |

These results show that the catalyst samples S5, S6, S7, S8 and S9 sulphurised in accordance with the process according to the invention have superior properties than the samples S1, S2, S3 and S4 sulphurised by means of processes that are not in accordance with the invention.

These results show that the process according to the invention gives the catalyst superior properties in terms of sulphurisation rate, reduction of the attrition and activity in various hydrotreatment reactions.

1. Process for sulphurising a hydrocarbon treatment catalyst, comprising:
(i) at least one step of placing the catalyst in contact with an emulsion comprising:
(ia) an aqueous phase comprising at least one acid; and
(ib) an organic phase; then
(ii) at least one step of placing the catalyst in contact with a sulphur-containing gaseous mixture containing hydrogen and a sulphur compound.

2. Process according to claim 1, wherein the aqueous phase (ia) comprises one or more acids, in free acid form or salified form, selected from mineral acids and organic acids, and mixtures thereof.

3. Process according to claim 1, wherein the one or more acids is a carboxylic acid selected from the group consisting of maleic acid, glycolic acid, thioglycolic acid, citric acid, and mixtures thereof.

4. Process according to claim 1, wherein the acid(s) represent(s) from 3 to 30% by weight, in relation to the total weight of the emulsion, this content being expressed based on the free acid form.

5. Process according to claim 1, wherein the aqueous phase (ia) represents from 40 to 70% by volume, in relation to the total volume of the emulsion.

6. Process according to claim 1, wherein the organic phase (ib) comprises one or more oils comprising at least one chain having at least 8 carbon atoms.

7. Process according to claim 6, wherein the organic phase (ib) comprises one or more mineral oils.

8. Process according to claim 6, wherein the organic phase (ib) comprises one or more vegetable oils.

9. Process according to claim 1, wherein the organic phase (ib) also comprises one or more sulphur compounds.

10. Process according to claim 1, wherein the aqueous phase (ia) also comprises one or more sulphur compounds.

11. Process according to claim 1, wherein the emulsion further comprises one or more surfactant(s).

12. Process according to claim 1, wherein the emulsion comprises one or more non-ionic surfactants selected from the group consisting of
oxyalkylated alkyl(C₈-C₂₄)phenols;
saturated or unsaturated, linear or branched, oxyalkylated or glycerolated C₈ to C₄₀ alcohols, and including one or two fatty chains;
saturated or unsaturated, linear or branched C₈ to C₃₀ acid esters, and polyol or polyethylene glycol esters;
esters of saturated or unsaturated, linear or branched C₈ to C₃₀ acids and of sorbitol;
fatty acid and saccharose esters,
alkyl(C₈-C₃₀)(poly)glucosides and alkenyl(C₈-C₃₀)(poly)glucosides, optionally oxyalkylated (0 to 10 oxyalkylene units) and comprising 1 to 15 glucose units; alkyl (C₈-C₃₀)(poly)glucoside esters,
saturated or unsaturated, oxyethylated vegetable oils;
ethylene oxide and/or propylene oxide condensates;
and mixtures thereof.

13. Process according to claim 11, wherein the one or more surfactant(s) are present in a total content ranging from 0.1 to 5% by weight, in relation to the total weight of the emulsion.

14. Process according to claim 1, wherein the volume of emulsion used in step (i) is higher than or equal to at least 80% of the total porous volume of the catalyst.

15. Process according to claim 1, wherein step (i) is performed at a temperature ranging from 25° C. to 100° C.

16. Process according to claim 1, wherein step (ii) is performed by placing the catalyst in contact with a sulphur-containing gaseous mixture containing hydrogen and hydrogen sulphide.

17. Process for treating a used catalyst, comprising:
a step of heat treating the catalyst in the presence of oxygen at a temperature ranging from 350° C. to 550° C., then;
sulphurising the catalyst by means of the process as defined in claim 1.
